(19) United States
(12) Patent Application Publication
(10) Pub. No.: US 2010/0091728 A1
(43) Pub. Date: Apr. 15, 2010

(54) METHOD FOR ALLOCATING RADIO RESOURCES

(75) Inventors: Jae-Heung Kim, Daejon (KR); Tae-Joong Kim, Gyeonggi-do (KR); Hyung-Cheol Shin, Daejon (KR); Kyoung-Seok Lee, Daejon (KR); Byung-Han Ryu, Daejon (KR); Seung-Chan Bang, Daejon (KR)

Correspondence Address: LAHIVE & COCKFIELD, LLP;FLOOR 30, SUITE 3000, ONE POST OFFICE SQUARE, BOSTON, MA, 02109, US

(73) Assignees: KT CORPORATION, Seongnam-city, Kyeonggi-do (KR); ELECTRONICS AND TELECOMMUNICATIONS RESEARCH INSTITUTE, DAEJON (KR)

(21) Appl. No.: 12/530,568

(22) PCT Filed: Feb. 29, 2008
(86) PCT No.: PCT/KR2008/001193

§ 371 Date: Sep. 9, 2009

(30) Foreign Application Priority Data
Mar. 9, 2007 (KR) 10-2007-0023696
Oct. 25, 2007 (KR) 10-2007-0107847

(51) Int. Cl. H04W 72/04

(52) U.S. Cl. 370/329

(57) ABSTRACT

Provided is a method for allocating radio resources in a mobile telecommunication system. The method for allocating a downlink radio resource in a base station includes retrieving a downlink radio resource allocated to a first mobile terminal if the first mobile terminal does not have a downlink packet, continuously checking whether or not there is a new downlink packet for the first mobile terminal, and retrieving a radio resource allocated to a second mobile terminal if there is a new downlink packet for the first mobile terminal and reallocating the retrieved radio resource to the first mobile terminal.

### TECHNICAL FIELD

The present invention relates to a method for allocating radio resources in a mobile telecommunication system; and, more particularly, to a method for allocating radio resources in a mobile telecommunication system in order to effectively allocate, retrieve, and reallocate radio resources according to presence of transmission packets by determining whether a transmission packet for a terminal exist or not, maintaining a corresponding radio resource if there is a transmission packet for the terminal, or temporally retrieving a corresponding radio resource if there is no transmission packet for the terminal.

This work was supported by the IT R&D program of MIC/IITA [2005-S-404-13, “Research & Development of Radio Transmission Technology for 3G evolution”].

### BACKGROUND ART

Unlike a circuit system, radio resources are shared by a plurality of terminals in a packet-based cellular system. In order to share the radio resources, it is necessary to have scheduling information related to radio resource allocation. However, the structure of scheduling information may vary according to a scheduling method. Also, the scheduling method may be differently applied according to a service type such as a real time service or a non real time service. Particularly, radio resources must be regularly allocated at a predetermined interval for the real time service.

Wideband Code Division Multiple Access (WCDMA) for circuit data transmission decides radio resource allocation through code division. Also, High Speed Downlink Packet Access (HSDPA) or high speed uplink packet access (HSUPA), which is a method for sharing a radio resource for packet data transmission, provides radio resource allocation information to terminals through a control channel using corresponding relation clearly defined through a unique channel code or a scramble code.

However, a long term evolution (LTE) system for providing various packet services employs a method of dynamically and flexibly allocating radio resources according to a service type in order to improve the usability of radio resources. Also, the LTE system uses a persistent scheduling method or a group scheduling method to reduce signaling overhead caused by transmitting scheduling information that informs radio resource allocation information in case of a real time service. That is, the persistent scheduling method or the group scheduling method is used for optimizing radio resource allocation.

The persistent scheduling method allocates a predetermined radio resource persistently to a predetermined terminal that receives a real time service for a predetermined duration through a setup process for service configuration. Such a persistent scheduling method can regularly allocate radio resource without additional signaling for scheduling.

However, the persistent scheduling method has a shortcoming in that the usability of radio resources is deteriorated because a corresponding radio resource is occupied by a predetermined terminal regardless of whether or not packet data remains. Therefore, the persistent scheduling method requires a method for allocating radio resources that improves the usability of radio resource by minimizing signaling overhead in scheduling radio resource for a real time packet service.

A current LTE system of 3GPP employs Orthogonal Frequency Division Multiple Access (OFDMA). The OFDMA system uses a two dimensional structure that discriminates a frequency and a time unlike CDMA that allocates codes to each of terminals.

Here, radio resources composed of a time and a frequency are divided and transmitted through downlink and uplink physical channels. The radio resource uses a radio resource block which is divided into a transmission time interval TTI and a sub carrier group. A radio frame forming such a radio resource is formed of a sub-frame (or TTI) of 1 millisecond. Therefore, in case of a radio frame of 10 milliseconds, 10 sub frames form one radio frame.

A scheduling operation for allocating a radio resource to transmit packet data is performed in a unit of TTI. Therefore, terminals receiving a packet service monitor a L1/L2 control signal resource block where scheduling information is transmitted at every TTI in order to transmit and receive data.

Here, the control signaling information includes a function of addressing a radio resource allocated for packet data transmission. The control signaling information is encoded by each terminal or each group. A terminal identifier such as cell-radio network temporary identifier (C-RNTI) is used for identifying a terminal or a terminal group in a base station for scheduling. The terminal identifier is inserted into the control signaling information. Also, if a terminal identifier or a group identifier is not inserted into the control signaling information, terminals can identify control signaling information by masking CRC using an identifier.

Recently, it is considered that the LTE system employs a different radio resource allocation method according to a packet service type and a quality of service (QoS). That is, a persistent or semi-static radio allocation method has been considered to be used for a real time service. The persistent or semi-static radio allocation method statically allocates radio resources at a regular time interval. Also, a dynamic allocation method allocating resources in a unit of TTI has been considered to be used for the non-real time service.

Particularly, a persistent scheduling method has been considered for a voice over IP (VoIP) service, one of representative real-time services. The persistent scheduling method does not transmit additional control signaling information for scheduling at a corresponding TTI in order to reduce an amount of transmitting control signaling information. In order to reduce or not to transmit control information for scheduling, the persistent scheduling method allocates a predetermined radio resource at a regular time interval according to a predetermined scheduling condition in consideration of service activity when a base station and a terminal setup services.

FIG. 1 is a diagram illustrating for AMR codec packet generation in a VoIP service which is a real time service according to the related art.

As shown in FIG. 1, a VoIP service period includes an active period 12 and a silent period 13 according to whether VoIP packets from an upper layer exist or not.

The active period 12 is a talkspurt period where a VoIP packet data 11 is generated because a user talks during a VoIP service. The VoIP packet data is inputted to a transmission buffer of a base station or a terminal at a regular interval in the active period 12.

If a user does not talk anymore, a silent period 13 is formed. VoIP packets are not generated in the silent period 13. Although the VoIP packets are not generated according to the real voice, silence descriptor (SID) packets 14, which are packet data with a predetermined pattern, are regularly generated and inputted to a transmission buffer.

Here, a scheduler of a base station could not be informed by adaptive multi-rate CODEC of or discriminate a transition time from the active period 12 to the silent period 13 or a transition time from the silent period 13 to the active period 12. Also, a scheduler of a base station could not determine whether a generated packet is a SID packet 14 in the silent period 13 or a newly started VoIP packet.

Since the scheduler of the base station is not informed of or accurately discriminates a transition time from one period to another period, the scheduler of the base station cannot retrieve radio resources that was allocated to a corresponding terminal at a transmission time from an active period to a silent period 13, cannot allocate the radio resources to other terminals, cannot reallocate the radio resources at a transition time 12 from a silent period to an active period 12, or cannot inform validity of existing allocation information.

A scheduler has a difficulty in determining whether the active period 12 is transited to the silent period 13 or vice versa through additional control signaling from a source CODEC. Therefore, the scheduler cannot be aware of transition during a VoIP service. Also, the scheduler cannot determine whether a VOIP packet data generated from a source CODEC and inputted to a transmission buffer is a SID packet 14 or not.

The silent period 13 is irregularly generated although it cannot be known in advance. However, a persistent scheduling requires a method of using radio resources unnecessarily occupied during the silent period 13.

FIG. 2 is a diagram illustrating a control signaling block and radio resource in a TTI forming a radio frame.

As shown in FIG. 2, downlink radio frame 20 from a base station to a terminal for transmitting packet data is divided into a plurality of TTIs 21. Each of the TTIs 21 includes a control signaling block 221 for transmitting scheduling information and a radio resource block 23 for transmitting packet data.

Here, the control signaling block 22 includes a downlink (DL) control signaling block 24 denoting scheduling information for a downlink (DL) radio resource and an uplink (UL) control signaling block 24 denoting scheduling information of an uplink radio resource. Each of the DL and UL control signaling blocks 24 and 25 is formed of scheduling information units 26 denoting DL and UL scheduling information for a predetermined terminal or a predetermined terminal group.

Therefore, terminals search DL scheduling information units 26 for receiving packet data transmitted from a base station and receives packet data through a designated downlink radio resource. Also, the terminals searches UL scheduling information units 25 and transmits packet data to a base station through a designated uplink radio resource.

Meanwhile, a persistent scheduling method does not use DL or UL scheduling information units 26 and 25 as shown in FIG. 2. As described above, the persistent scheduling method transmits packet data by occupying downlink or uplink radio resources according to a predetermined method.

As described above, a terminal occupies a radio resource regardless of whether there are packet data to be transmitted in the related art. Therefore, the usability of a radio resource is deteriorated.

### DISCLOSURE OF INVENTION

### Technical Problem

An embodiment of the present invention is directed to providing a method for allocating radio resources in a mobile telecommunication system, which can effectively allocate, retrieve, and reallocate radio resources according to presence of transmission packets by determining whether a base station has a transmission packet for a terminal, maintaining a corresponding radio resource if the transmission packet for the terminal exists or temporally retrieving a corresponding radio resource if the transmission packet for the terminal does not exist.

Another embodiment of the present invention is directed to providing a method for allocating a radio resource in a mobile telecommunication system, which can effectively allocate, retrieve, and reallocate radio resources according to whether a packet is generated or not in case of a real time service that regularly allocates a radio resource by observing a transmission buffer for a mobile terminal having an allocated radio resource, retrieving the allocated radio resource if packet data is not inputted for a predetermined time, and reallocating the retrieved radio resource to another terminal.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In the present invention, it is determined whether a there is a packet for a mobile terminal allocated with a radio resource in a mobile communication system. The radio resource is maintained if the transmission packet for the terminal exists, or the radio resource is temporally retrieved if no transmission packet exists for a terminal. The retrieved radio resource is allocated to another mobile terminal.

In accordance with an aspect of the present invention, there is provided a method for allocating a downlink radio resource in a base station, including: retrieving a downlink radio resource allocated to a first mobile terminal if there is no downlink packet for the first mobile terminal ; continuously determining whether or not there are new downlink packets for the first mobile terminal; and retrieving a radio resource allocated to a second mobile terminal if there are new downlink packets for the first mobile terminal and reallocating the retrieved radio resource to the first mobile terminal.

In accordance with another aspect of the present invention, there is provided a method for allocating a downlink radio resource in a mobile terminal, including: receiving a downlink packet from a base station through a downlink radio resource allocated according to a persistent scheduling algorithm; searching scheduling control information after transmitting a retrieval response for downlink radio resources to be retrieved by the base station to the base station and temporally retrieving a downlink radio resource; and receiving a downlink packet through a downlink radio resource reallocated by the base station according to the searched scheduling control information.

In accordance with another aspect of the present invention, there is provided a method for allocating an uplink radio resource in a base station, including: determining whether it is necessary to retrieve a pre-allocated uplink radio resource according to a state of using an uplink radio resource in a first mobile terminal; retrieving a pre-allocated uplink radio resource temporally if it is necessary to retrieve the radio resource and allocating the retrieved uplink radio resource to a second mobile terminal; and retrieving a radio resource allocated to the second mobile terminal according to a request of the first mobile terminal and reallocating the retrieved radio resource to the first mobile terminal.

The method may further include: informing the first mobile terminal that a pre-allocated uplink radio resource is not retrieved if it is not necessary to retrieve the uplink radio resource in the determining whether it is necessary to retrieve a pre-allocated uplink radio resource.

In accordance with another aspect of the present invention, there is provided a method for allocating an uplink radio resource in a mobile terminal, including: reporting that an uplink radio resource is retrievable to a base station because the mobile terminal has no uplink packet to be transmitted through an uplink radio resource; continuously determining whether the mobile terminal has a new uplink packet or not after the base station temporally retrieves an uplink radio resource; and reallocating an uplink radio resource by requesting the base station to reallocate the temporally retrieved uplink radio resource if the mobile terminal has the new uplink packet.

### Advantageous Effects

A method for allocating a radio resource in a mobile telecommunication system according to an embodiment of the present invention can effectively allocate, retrieve, and reallocate a radio resource according whether there is a packet to be transmitted to a mobile terminal allocated with a radio resource.

Particularly, the method for allocating a radio resource according to the present invention retrieves a radio resource not in use by observing a transmission buffer or based on a timer when there is no transmission packet data for a terminal in case of a persistent scheduling method for a real time service. Therefore, limited radio resources can be variably and flexibly used.

Furthermore, the method for allocating a radio resource according to the present invention retrieves a radio resource of the terminal if there is no packet data to be transmitted to/from a certain terminal for a predetermined time and then allocates the retrieved radio resource to another terminals when a radio resource is scheduled based on a persistent scheduling method or a semi-static scheduling method for a real time service. Therefore, the usability of a radio resource is improved.

### BRIEF DESCRIPTION OF THE DRAWINGS

FIG. 1 illustrates AMR codec packet generation in a conventional non-realtime VoIP service.

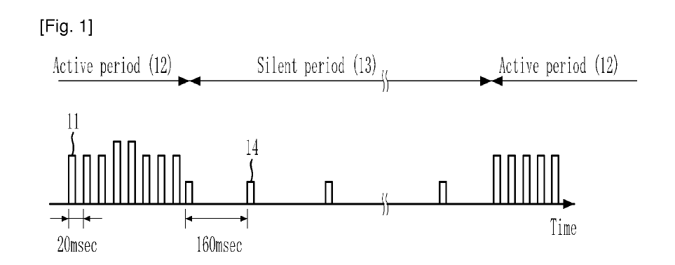

FIG. 2 illustrates a control signaling block and radio resource in a TTI forming a radio frame.

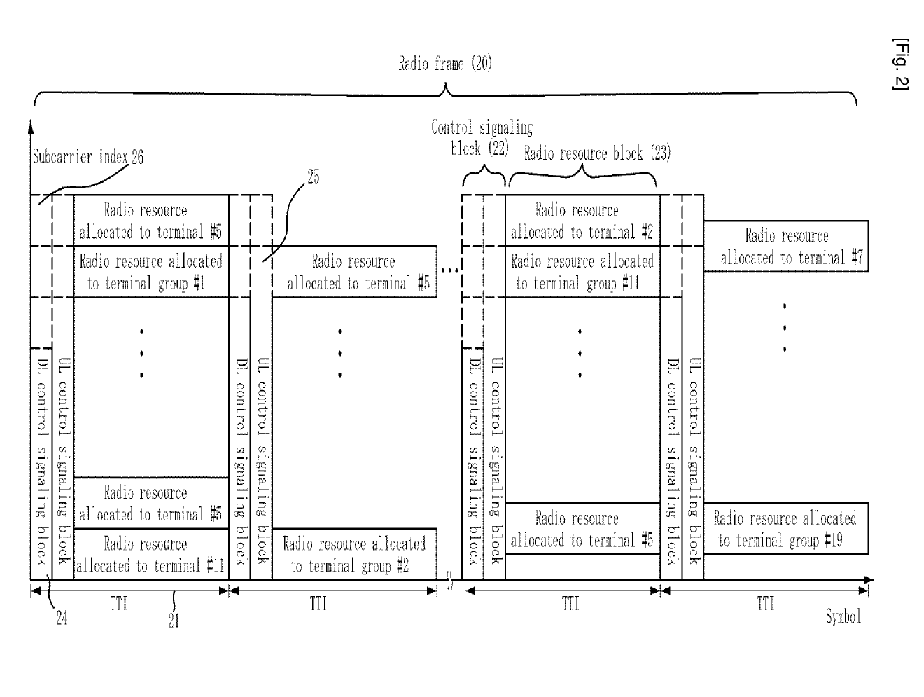

FIG. 3 is a flowchart illustrating a process of allocating downlink (DL) radio resources in a radio resource allocation method for a telecommunication system in accordance with an embodiment of the present invention.

FIG. 4 is a timing diagram for the method shown in FIG. 3.

FIG. 5 is a flowchart illustrating a method for allocating an uplink (UL) radio resource in a radio resource allocation method for a telecommunication system in accordance with an embodiment of the present invention.

FIG. 6 is a timing diagram for the UL resource allocation method shown in FIG. 5.

### MODE FOR THE INVENTION

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

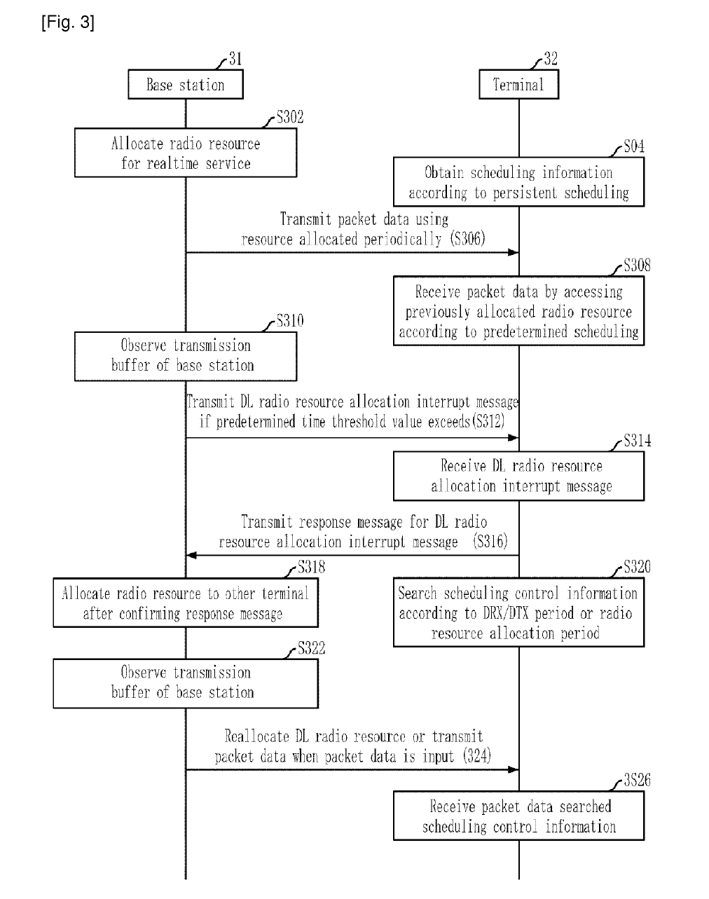

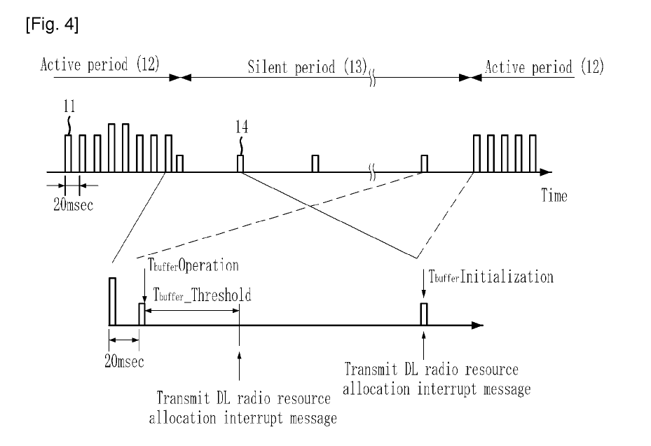

FIG. 3 is a flowchart illustrating a process of allocating downlink (DL) radio resources in a radio resource allocation method for a telecommunication system in accordance with an embodiment of the present invention, and FIG. 4 is a timing diagram for the method shown in FIG. 3.

The DL radio resource allocation method according to the present embodiment estimates a silent period for a real time service, for example, a VoIP service, by analyzing a state of a transmission buffer of a base station 31, retrieves radio resources which were allocated to a terminal 32 according to a persistent scheduling method, and re-allocates the retrieved radio resources when transmission packet data is generated. Therefore, the DL radio resource allocation method according to the present embodiment prevents DL radio resources from being ineffectively occupied.

Hereinafter, a DL radio resource allocation method in a cellular system for packet transmission according to the present embodiment will be described with reference to FIGS. 3 and 4.

At step S302, a base station 31 allocates a DL radio resource to a terminal 32 for a real time service during a negotiation process for call set-up, which is performed when a related service starts.

At step S304, the terminal 32 obtains scheduling information according to a persistence scheduling method through a control message for call set-up from the base station 31. That is, the terminal 32 obtains general properties for DL radio resource scheduling patterns through scheduling information, for example, a scheduling period, allocated radio resources, or a transmit format of packet data such as modulation information and encoding information.

At step S306, the base station 31 transmits packet data to the terminal 32 through the radio resource allocated at the step S302.

Then, the terminal 32 receives packet data by accessing the previously allocated radio resource according to the obtained scheduling information at step S308 without using scheduling information transmitted at every TTI.

Then, the base station 31 observes a transmission buffer of the base station 31 for real time service at step S310.

Hereinafter, an operation for observing a transmission buffer at the base station will be described with reference to FIGS. 3 and 4. The base station 31 turns on a transmission buffer observation timer T_{buffer} if no packet data is in the transmission buffer. Here, a time interval between packets is assumed about 20 msec. The base station 31 turns on the transmission buffer observation timer T_{buffer} 20 msec at the end of the active period 12. Also, the base station 31 may turn on a transmission buffer observation timer at the same time when it transmits the last packet data stored in the transmission buffer. On the contrary, the base station 31 resets a transmission buffer observation timer when packet data is inputted to the transmission buffer from an upper layer.

Here, the base station 31 generates a DL resource allocation interruption message for retrieving radio resources which are allocated to the terminal 32 according to a persistence scheduling method if a value of a transmission buffer observation timer (T_{buffer}) is larger than a predetermined threshold value at step S312. Here, the DL radio resource allocation interruption message is generated and transmitted at a layer that dynamically allocates a radio resource, such as a MAC control PDU or a RRC message.

At step S314, the terminal 32 receives the DL radio resource allocation interruption message transmitted from the step S312. Then, the terminal 32 transmits a response message for the received DL radio resource allocation interruption message to the base station 31 at step S316.

Then, the base station 31 confirms the response message from the terminal 32 and allocates corresponding radio resources to other terminal at step S318. Therefore, the usability of radio resources can be improved. Here, the base station 31 confirms through ACK or NACK response information from the terminal 32 as the response message for a hybrid automatic repeat request (HARQ) operation. Here, the HARQ operation is for a radio resource that transmits the DL radio resource allocation interruption message. The base station 31 may also confirm a control message, such as a MAC control PDU message or a RRC message, from the terminal 32 as the response message for the DL radio resource allocation interruption message. The base station 31 repeats the step S312 and following steps if the base station 31 receives the NACK response information or corresponding response message thereof.

When the terminal 32 receives the DL radio resource allocation interruption message, the terminal 32 is aware of that previous radio resource allocation information is invalid. The terminal 32 searches scheduling control information according to a radio resource allocation period in previous scheduling information or a DL radio resource allocation period in the DL radio resource allocation interruption message at step S320. Therefore, the terminal 32 receiving the DL radio resource allocation interruption message searches downlink control information in a DL signaling block according to an allocation period and does not transmit ACK or NACK response information for HARQ operation to the base station 31 according to an interval allocated in the previous scheduling information which is not valid anymore.

The base station 31 allocates radio resources to other terminals at step S318 and observes a transmission buffer of the base station 31 at step S322. If packet data is inputs the transmission buffer again, the base station 31 resets the transmission buffer observation timer T_{buffer}, re-allocates a DL radio resource to a predetermined terminal 32, and retransmits packet data to the terminal 32 using DL scheduling control information at step S324. In case of a VoIP service, the base station 31 may observe the transmission buffer for a predetermined time duration such as 30 ms before it transmits the packet data in order to determine whether input packet is a silence indication duration (SID) packet that is transmitted regularly or at one time in a silence period or to determine whether it is a transition time from a silent period to an active period where a voice signal packet starts.

While the terminal 32 searches DL scheduling control information according to a discontinuous reception (DRX)/discontinuous transmission (DTX) period, a radio resource allocation period in previous scheduling information, or a DL radio resource allocation period in a DL radio resource allocation interruption message, the terminal 32 confirms a DL scheduling information unit including an own scheduling identifier (ID) and receives packet data of a radio resource assigned by the scheduling information unit at step S326. After the terminal 32 confirms the DL scheduling control information according to a radio resource reallocation method of the base station 31, the terminal 32 operates according to a predefined persistent scheduling information pattern during call set-up, for example, according to a scheduling period, allocated radio resources, or a transmit format of packet data such as modulation information and encoding information. Or, the terminal 32 is allocated with a new persistent scheduling information pattern from the base station 31 and receives packet data according to the new persistent scheduling information pattern. Here, the terminal 32 can be aware of whether corresponding scheduling information is persistent (persist_ind=“1”) or temporal (persist_ind=“0”) using an additional control field in a scheduling information unit.

After reallocating a DL radio resource and transmitting packet data, the base station 31 can check whether the terminal 32 can normally receives the packet data or not through ACK/NACK information for HARQ operation or additional response messages such as a MAC control PDU or a RRC message from the terminal 32. That is, the base station 31 uses the response message to check whether the terminal 32 normally receives packet data and information about reallocation of a DL radio resource or not. The base station 31 transmits packet data with DL radio resource real-location information if the base station 31 receives NACK information.

After confirming the terminal 32 normally receives the packet data, the base station 31 repeats the step S306 and following steps if the DL radio resource allocation is persistent at the step S324, that is, persist_ind is ‘1’ in the scheduling information unit. On the contrary, the base station 31 repeats the step S234 if the DL radio resource allocation is temporal at the step S324, that is, persist ind is ‘0’.

The terminal 32 repeats the step S308 and following steps if the DL radio resource allocation is persistent at the step S324. The terminal 32 repeats the step S320 if the DL radio resource allocation is temporal at the step S324.

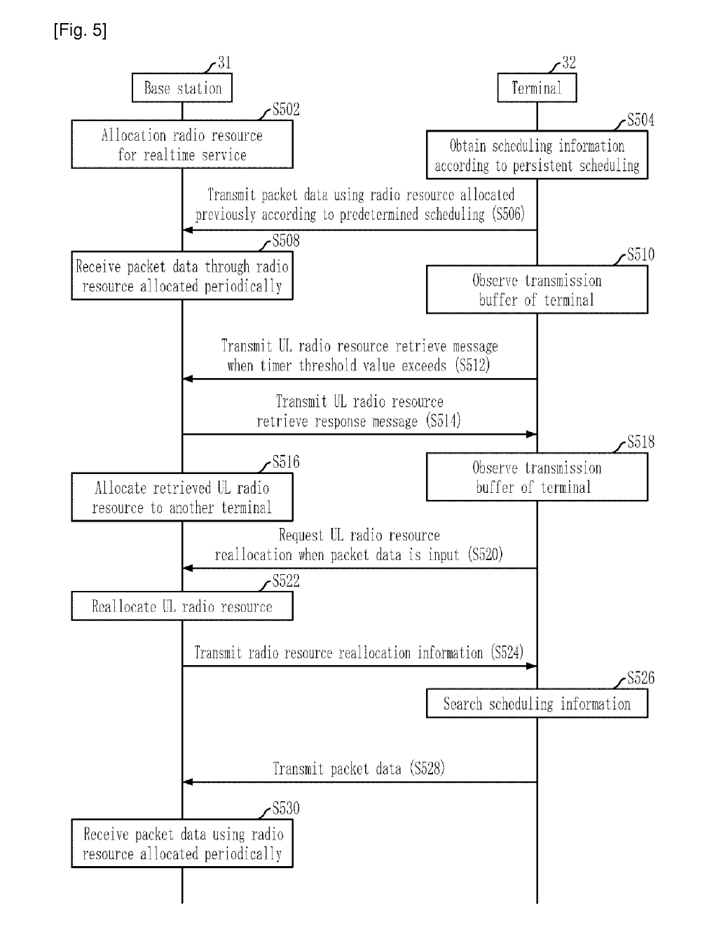

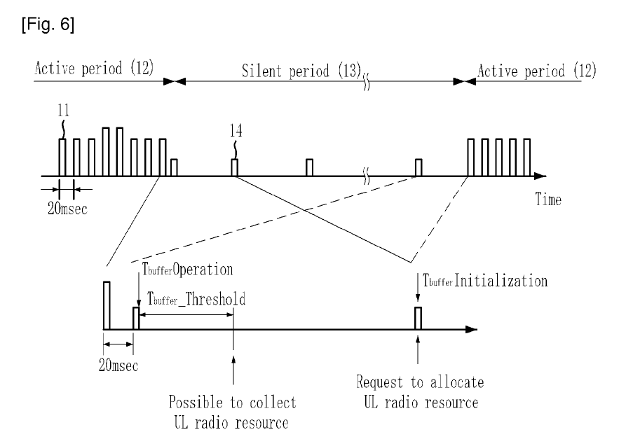

FIG. 5 is a flowchart illustrating a method for allocating an uplink (UL) radio resource in a radio resource allocation method for a telecommunication system in accordance with an embodiment of the present invention, and FIG. 6 is a timing diagram for the UL resource allocation method shown in FIG. 5.

FIG. 5 shows a procedure of estimating a silent period for a real time service such as a VoIP service by observing a state of a transmission buffer at a terminal and reporting the estimated silent period to a base station, and a procedure of retrieving radio resources allocated to a predetermined terminal according to a persistent scheduling method at a base station and reallocating the retrieved radio resources when transmit packet data is generated. Therefore, the UL radio resource allocation method according to the present embodiment can prevent UL radio resources from being occupied ineffectively.

At step S502, a base station 31 allocates UL radio resources to a terminal 32 for a real time service during a negotiation process for call setup for starting a service.

The terminal 32 obtains scheduling information according to a persistent scheduling method through a control message for call setup from the base station 31 at step S504. That is, the terminal 32 obtains normal properties for a UL radio resource scheduling pattern, for example, a scheduling period, an allocation radio resource, or a transmit format of packet data such as modulation and encoding information.

At step S506, the terminal 32 transmits packet data using a UL radio resource allocated according to an interval of a scheduling pattern defined according to a persistent scheme or a semi-static scheme instead of UL scheduling control information received at TTI.

At step S508, the base station 31 receives uplink packet data through a regularly allocated UL radio resource.

Meanwhile, the terminal 32 observes a transmission buffer while transmitting UL packet data to the base station 31 at step S510.

Hereinafter, a procedure of observing a transmission buffer will be described with reference to FIGS. 5 and 6. The terminal 32 turns on a transmission buffer observation timer T_{buffer} if no packet data is stored in a transmission buffer. Also, the terminal 32 may start a transmission buffer observation timer at the same time of transmitting the last packet data stored in a transmission buffer. On the contrary, the terminal 32 resets a transmission buffer observation timer T_{buffer} when packet data is inputted to a transmission buffer from an upper layer.

Here, if the value of a transmission buffer timer T_{buffer} becomes larger than a predetermined threshold T_{buffer—} Threshold, the terminal 32 generates a UL radio resource retrieve message to a base station 31 in order to enable the base station 31 to retrieve UL radio resources that are allocated to the terminal 32 according to a persistent scheduling method at step S512. The UL radio resource retrieve message such as a MAC control PDU or a RRC message is generated at a layer that manages scheduling of the terminal 32 and transmitted to the base station 31.

After the base station 31 receives the UL radio resource retrieve message, the base station 31 confirms that a corresponding terminal 32 does not need an UL radio resource for a predetermined time. The base station 31 may transmit a UL radio resource retrieve response message to the corresponding terminal 32 at step S514.

At step S516, the base station 31 is informed that corresponding radio resources are retrieved based on a report of the terminal 32, which informs start of a silent period through the UL radio resource retrieve response message. Otherwise, the terminal 32 may report that the allocated radio resources are not retrieved. That is, if an uplink radio resource is available or if a scheduler of the base station 31 determines that it is not proper to retrieve a radio resource allocated to the corresponding terminal 32, the terminal 32 reports that the allocated radio resources are not retrieved.

At step S518, the terminal 32 receives the radio resource response message transmitted from the step S514 and observes a transmission buffer of the terminal.

The terminal 32 resets a transmission buffer observation timer T_{buffer} if packet data is inputted to the transmission buffer from an upper layer and transmits information requesting UL radio resource allocation at step S520. Here, such a radio resource real-location requesting procedure is performed only in the terminal 32 that receives information that informs radio resource retrieve in a radio resource retrieve response message transmitted at the step S514.

According to a radio resource reallocation request 520, the base station 31 reallocates a UL radio resource to the corresponding terminal 32 at step S522. That is, the base station 31 may allocate radio resources based on a radio resource reallocation scheme of the base station 31 according to a persistent scheduling information pattern that was defined during call setup or a new persistent scheduling information pattern. Here, the persistent scheduling information pattern includes a scheduling interval, allocated radio resources, or a transmit format of packet data such as modulation information and encoding information.

After receiving a request of allocating a UL radio resource from the terminal 32, the base station 31 transmits scheduling information which is radio resource reallocation information for allocating UL radio resources at step S524.

At step S526, the terminal 32 searches scheduling control information. That is, the terminal 32 confirms a UL scheduling information unit including an own scheduling identifier in UL scheduling control information by searching scheduling control information.

Then, the terminal 32 transmits packet data through a UL radio resource assigned by the UL scheduling information unit at step S528. The base station 31 receives packet data through a radio resource that is regularly allocated at step S530.

Meanwhile, if the terminal 32 is informed that a radio resource is not retrieved and continuously valid through the UL radio resource retrieve response message at the step S514, the terminal 32 does not perform the step S520. If new packet data is inputted to a transmission buffer from an upper layer after the silent period ends, the terminal 32 may transmit packet data through a radio resource assigned by the previous scheduling information.

Then, the terminal 32 repeats the steps S504, S506, and 510, and the base station 31 performs the step S508.

The method of the present invention described above may be programmed for a computer. Codes and code segments constituting the computer program may be easily inferred by a computer programmer of ordinary skill in the art to which the present invention pertains. The computer program may be stored in a computer-readable recording medium, i.e., data storage, and it may be read and executed by a computer to realize the method of the present invention. The recording medium includes all types of computer-readable recording media.

The present application contains subject matter related to Korean Patent Application Nos. 10-2007-0023696 and 10-2007-0107847, filed in the Korean Intellectual Property Office on Mar. 9, 2007, and Oct. 25, 2007, respectively, the entire contents of which is incorporated herein by reference.

While the present invention has been described with respect to certain preferred embodiments, it will be apparent to those skilled in the art that various changes and modifications may be made without departing from the scope of the invention as defined in the following claims.

1. A method for allocating a downlink radio resource in a base station, comprising the steps of:
retrieving a downlink radio resource allocated to a first mobile terminal if there is no downlink packet for the first mobile terminal;
continuously checking whether or not there is a new downlink packet for the first mobile terminal without a downlink radio resource; and
retrieving a radio resource allocated to a second mobile terminal if there is a new downlink packet for the first mobile terminal and reallocating the retrieved radio resource to the first mobile terminal.

2. The method of claim 1, wherein the step of retrieving a downlink radio resource includes:
checking whether there is a downlink packet or not for the first mobile terminal with the downlink radio resource allocated thereto at a predefined time;
maintaining the allocated downlink radio resource if there is a downlink packet for the first mobile terminal; and
temporally retrieving the allocated downlink radio resource if there is no downlink packet for the first mobile terminal and allocating the retrieved radio resource to the second mobile terminal.

3. The method of claim 2, wherein in the step of temporally retrieving the allocated downlink radio resource, time when there is no downlink packet for the first mobile terminal is measured, and the downlink radio resource allocated to the first mobile terminal is temporally retrieved if the measured time exceeds a predetermined threshold.

4. The method of claim 3, wherein in the step of temporally retrieving the allocated downlink radio resource, if the measured time exceeds the predetermined threshold, a radio resource allocation interrupt message is generated and transmitted to the first mobile terminal, and a response message to the radio resource allocation interrupt message is received.

5. The method of claim 2, wherein in the step of continuously determining whether or not there is a new downlink packet for the first mobile terminal, a transmission buffer is regularly checked to see whether a new downlink packet is inputted to a transmission buffer or not in order to determine whether there is the new downlink packet for the first mobile terminal or not.

6. The method of claim 5, wherein in the step of continuously determining whether or not there are new downlink packets for the first mobile terminal, it is determined whether a downlink packet inputted to the transmission buffer is a packet temporally transmitted in a silent period or a voice signal packet that transits the silent period to an active period, and it is determined that there is a new downlink packet for the first mobile terminal if the downlink packet inputted to the transmission buffer is the voice signal packet.

7. A method for allocating a downlink radio resource in a mobile terminal, comprising the steps of:
receiving a downlink packet from a base station through a downlink radio resource allocated according to a persistent scheduling algorithm;
searching scheduling control information after transmitting a retrieve response for downlink radio resources to be retrieved by the base station to the base station and temporally retrieving a downlink radio resource; and
receiving a downlink packet through a downlink radio resource reallocated by the base station according to the searched scheduling control information.

8. The method of claim 7, wherein in the step of searching scheduling control information, the mobile terminal does not transmit uplink acknowledgement (ACK) or non-acknowledgement (NACK) information for a hybrid automatic repeat request (HARQ) operation for the allocated downlink radio resource after transmitting the retrieve response to the base station.

9. A method for allocating an uplink radio resource in a base station, comprising the steps of:
checking whether it is necessary to retrieve a pre-allocated uplink radio resource according to whether an uplink radio resource allocated to a first mobile terminal is used;
temporally retrieving a pre-allocated uplink radio resource if the radio resource needs to be retrieved and allocating the retrieved uplink radio resource to a second mobile terminal; and
retrieving the radio resource allocated to the second mobile terminal according to a request of the first mobile terminal and reallocating the retrieved radio resource to the first mobile terminal.

10. The method of claim 9, further comprising the step of:
informing the first mobile terminal that a pre-allocated uplink radio resource is not retrieved if the uplink radio resource does not have to be retrieved in the step of determining whether it is necessary to retrieve a pre-allocated uplink radio resource retrieve.

11. The method of claim 9, wherein in the step of determining whether it is necessary to retrieve a pre-allocated uplink radio resource, whether a pre-allocated uplink radio resource needs to be retrieved is determined based on a radio resource retrieve message transmitted from the first mobile terminal.

12. A method for allocating an uplink radio resource in a mobile terminal, comprising the steps of:
reporting that an uplink radio resource is retrievable to a base station because the mobile terminal has no uplink packet to be transmitted through an uplink radio resource;
continuously checking whether the mobile terminal has a new uplink packet or not after the base station temporally retrieves an uplink radio resource; and
reallocating the uplink radio resource by requesting the base station to reallocate the temporally retrieved uplink radio resource when the mobile terminal has the new uplink packet.

13. The method of claim 12, wherein the step of reporting that an uplink radio resource is retrievable includes the steps of:
checking whether the mobile terminal has an uplink packet to transmit through an uplink radio resource or not at a predetermined time;
transmitting an uplink packet to the base station if the mobile terminal has the uplink packet; and
reporting that an uplink radio resource is retrievable to the base station when the mobile terminal does not have an uplink packet.

14. The method of claim 13, wherein in the step of reporting that an uplink radio resource is retrievable, time when there is no uplink packet is measured, and an uplink radio resource retrieve message is transmitted to the base station when the measured time exceeds a predetermined threshold.
